(19) United States
(12) Patent Application Publication
(10) Pub. No.: US 2013/0222094 A1
(43) Pub. Date: Aug. 29, 2013

(54) METHOD OF MANUFACTURING MAGNET AND MAGNET

(71) Applicant: JTEKT Corporation, (US)

(72) Inventors: Toshiyuki BABA, Kashihara-shi (JP); Koji NISHI, Anjo-shi (JP)

(73) Assignee: JTEKT CORPORATION, Osaka-shi (JP)

(21) Appl. No.: 13/778,608

(22) Filed: Feb. 27, 2013

(30) Foreign Application Priority Data
Feb. 27, 2012 (JP) 2012-040136

(51) Int. Cl. H01F 41/02; H01F 1/01

(52) U.S. Cl. CPC H01F 41/0266; H01F 1/01
USPC 335/302; 264/613

(57) ABSTRACT

Material powders made of a R—Fe—N compound that contains a light rare earth element as R or material powders made of a Fe—N compound are formed into a compact having a predetermined shape through compression forming. Then, the compact formed of the material powders is heated in an oxidative atmosphere to bond the material powders to each other by oxide films formed on the material powders.

### INCORPORATION BY REFERENCE

The disclosure of Japanese Patent Application No. 2012-040136 filed on Feb. 27, 2012 including the specification, drawings and abstract is incorporated herein by reference in its entirety.

### BACKGROUND OF THE INVENTION

1. Field of the Invention

The invention relates to a method of manufacturing a magnet, and a magnet.

2. Description of Related Art

Neodymium magnets (Nd—Fe—B magnets) have been used as high performance magnets. However, dysprosium (Dy), which is expensive and rare, is used to manufacture high performance neodymium magnets. Therefore, development of magnets that are manufactured without using dysprosium has been promoted recently.

Sm—Fe—N magnets that are manufactured without using dysprosium are known. However, because the decomposition temperature of a Sm—Fe—N compound is low, it is difficult to subject the Sm—Fe—N compound to high temperature sintering. If the Sm—Fe—N compound is sintered at a temperature equal to or higher than the decomposition temperature, the compound is decomposed. This may cause a possibility that the magnet will not be able to exhibit its performance as a magnet. Thus, material powders of the compound are bonded by a bonding agent. However, using the bonding agent causes a decrease in the density of the material powders of the magnet, which may be a factor of a decrease in the residual magnetic flux density.

Japanese Patent Application Publication No. 2005-223263 describes manufacturing a rare earth permanent magnet by forming oxide films on Sm—Fe—N compound powders, forming the compound powders into a compact having predetermined shape through compression preforming performed in a non-oxidative atmosphere, and then consolidating the compact at a temperature of 350° C. to 500° C. in a non-oxidative atmosphere. In this way, it is possible to manufacture a Sm—Fe—N magnet at a temperature lower than the decomposition temperature.

However, oxide films may cause a decrease of the residual magnetic flux density. Accordingly, if an oxide film is formed on the entirety of the outer face of each of the compound powders, the residual magnetic flux density decreases.

### SUMMARY OF THE INVENTION

It is an object of the invention to provide a method of manufacturing a magnet with which a high residual magnetic flux density is obtained, without using dysprosium and without using a bonding agent, and a magnet.

An aspect of the invention relates to a method of manufacturing a magnet, including: a forming step of forming material powders made of a R—Fe—N compound that contains a light rare earth element as R or material powders made of a Fe—compound into a compact having a predetermined shape through compression forming; and an oxidation-firing step of heating the compact formed of the material powders in an oxidative atmosphere to bond the material powders to each other by oxide films formed on the material powders.

### BRIEF DESCRIPTION OF THE DRAWINGS

The foregoing and further features and advantages of the invention will become apparent from the following description of example embodiments with reference to the accompanying drawings, wherein like numerals are used to represent like elements, and wherein:

FIG. 1 is a flowchart for describing a method of manufacturing a magnet according to an embodiment of the invention;

FIG. 2 is a graph showing a heat treatment process in an oxidation-firing step shown in FIG. 1;

FIG. 3 is a schematic sectional view illustrating the microscopic structure before the oxidation-firing step shown in FIG. 1;

FIG. 4 is a schematic sectional view illustrating the microscopic structure after the oxidation-firing step shown in FIG. 1;

FIG. 5 is a microphotograph (×8000) illustrating an outer face before the oxidation-firing step in the embodiment; and

FIG. 6 is a microphotograph (×8000) illustrating the outer face after the oxidation-firing step in the embodiment.

### DETAILED DESCRIPTION OF EMBODIMENTS

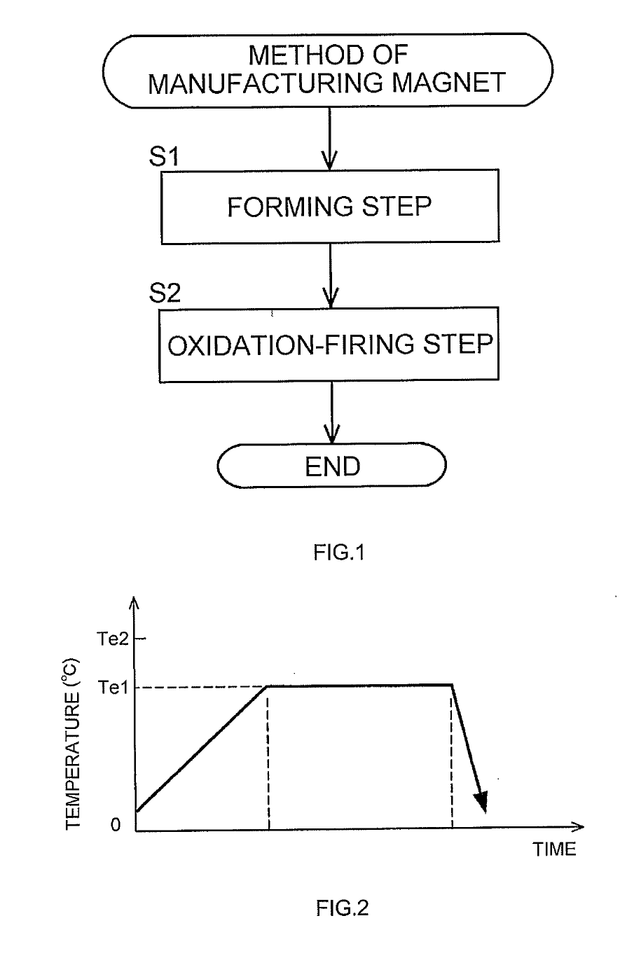

Hereinafter, a method of manufacturing a magnet according to an embodiment of the invention will be described with reference to FIG. 1 to FIG. 4. As shown in FIG. 1, material powders 10 used to manufacture the magnet are formed into a compact having a predetermined shape through compression forming (step S1: forming step). A R—Fe—compound that contains a light rare earth element as R, or a Fe—N compound is used as the material powders 10 used to manufacture the magnet. Sm is preferably used as the light rare earth element R. That is, Sm₂Fe₁₇N₃ or Fe₁₆N₂ is preferably used as the material powders 10 used to manufacture the magnet.

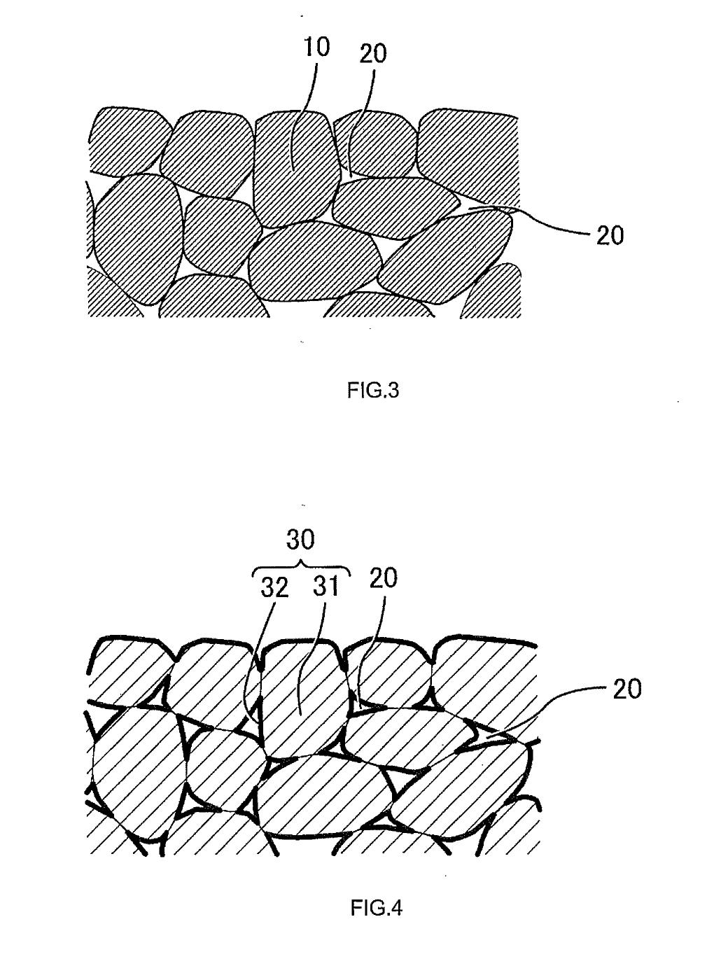

FIG. 3 is a schematic sectional view showing the microscopic structure of the compact. In the compact formed in the forming step, the material powders 10 are not deformed at all or deformed just slightly due to compression. Accordingly, although the material powders 10 are partially contact each other, clearances 20 are formed between the material powders 10. Preferably, the compact is formed in an oxidative atmosphere in order to allow oxidizing gas to enter the clearances 20. Note that, adhesive agents such as a bonding agent are not used in the forming step. Therefore, the bonding strength of the material powders 10 is low.

When the material powders 10 made of, for example, Sm₂Fe₁₇N₃ are used, the average particle diameter of the material powders 10 is approximately 3 μm and the compact has a minimum thickness of approximately 2 mm, and a pressure applied to form the compact is approximately 50 MPa. Further, when the material powders 10 made of Fe₁₆N₂ are used, manufacturing parameters substantially equal to those for the material powders 10 made of Sm₂Fe₁₇N₃ may be used.

Next, the compact formed in the forming step is heated in an oxidative atmosphere (step S2: oxidation-firing step). The oxidation-firing step is carried out with the compact placed in a heating furnace in which heating is performed using microwaves, an electric furnace, a plasma furnace, a high-frequency heating furnace, a heating furnace in which heating is performed using an infrared heater or the like. The heat treatment process in the oxidation-firing step is as shown in FIG. 2.

A heating temperature Te1 is set lower than a decomposition temperature Te2 of compound material powders. For example, when the material powders 10 of

Sm₂Fe₁₇N₃ are used, the heating temperature Te1 is set lower than 500° C. because the decomposition temperature Te2 of the compound is approximately 500° C. For example, the heating temperature Te1 is set to approximately 200° C. The same applies to the case where the material powders of Fe₁₆N₂ are used.

Further, the oxygen density and the gas pressure of the oxidative atmosphere are not particularly limited as long as the material powders are oxidized. The oxygen density and the gas pressure of the oxidative atmosphere may be substantially equal to the oxygen density in the atmospheric air and the atmospheric pressure, respectively. Thus, it is not necessary to particularly control the oxygen density and the gas pressure. Accordingly, the material powders may be heated in an atmosphere of the atmospheric air. Further, by setting the heating temperature Te1 to approximately 200° C., oxide films are formed regardless of whether the material powders of Sm₂Fe₁₇N₃ are used or the material powders of Fe₁₆N₂ are used.

FIG. 4 is a schematic sectional view showing the microscopic structure of the compact after the oxidation-firing step. By heating the compact in the oxidative atmosphere, exposed faces of the material powders 30 chemically react with oxygen, and as a result, oxide films 32 (as indicated by the bold lines in FIG. 4) are formed. The oxide films 32 bond adjacent material powders 30 to each other, and accordingly, a sufficient strength of the compact is ensured.

As shown in FIG. 3, in the compact before the oxidation-firing step, the material powders 10 are partially contact each other, and the clearances 20 are formed between the material powders 10. In the oxidation-firing step, the oxide films 32 are formed on the material powders at their outer face sides exposed to the clearances 20, and the oxide films 32 bond adjacent material powders 30 to each other. That is, the oxide films 32 are formed on the parts of the material powders 30, which are exposed to the clearances 20, while the parts of the material powders 30, which are not exposed to the clearances 20, are used as a base material 31. Thus, the oxide film 32 is not formed on the entirety of the outer face of each material powder 30. Because the amount of the oxide films 32 is set to the smallest possible amount at which a sufficient bonding strength of the material powders 30 is ensured, it is possible to suppress a decrease in the residual magnetic flux density of the magnet due to formation of the oxide films 32. Therefore, it is possible to manufacture a magnet which is inexpensive and which exhibits a high performance.

Further, according to the manufacturing method described above, the R—Fe—N compound or the Fe—N compound is used, and accordingly, it is possible to avoid using dysprosium. Thus, a magnet is manufactured at low cost. Further, because the R—Fe—N compound and the Fe—N compound each have a low decomposition temperature, it is difficult to apply high temperature sintering. However, because the compound is heated at a temperature lower than its decomposition temperature Te2 in the oxidation-firing step, it is possible to prevent the compound from being decomposed. Thus, it is possible to prevent a decrease in the residual magnetic flux density of the magnet due to decomposition of the compound. As a result, it is possible to reliably manufacture a magnet having a high residual magnetic flux density.

Sm₂Fe₁₇N₃ manufactured by Nichia Corporation and described in Japanese Patent Application Publication No. 2000-104104 was used as the material powders. Specifically, Sm₂Fe₁₇N₃ having an average particle diameter of 3 μm was used as the material powders. The material powders were then pressed in a cold-forming step by a magnetic field orientation press under a pressure of 50 MPa to form a compact having a shape of a rectangular parallelepiped of 10 mm×30 mm×2 mm. Then, in the oxidation-firing step, the thus formed compact was heated in an atmosphere of the atmospheric air within an electric furnace. In the heat treatment process, the heating temperature Te1 was 200° C. and the temperature increase rate was 2.25° C./min.

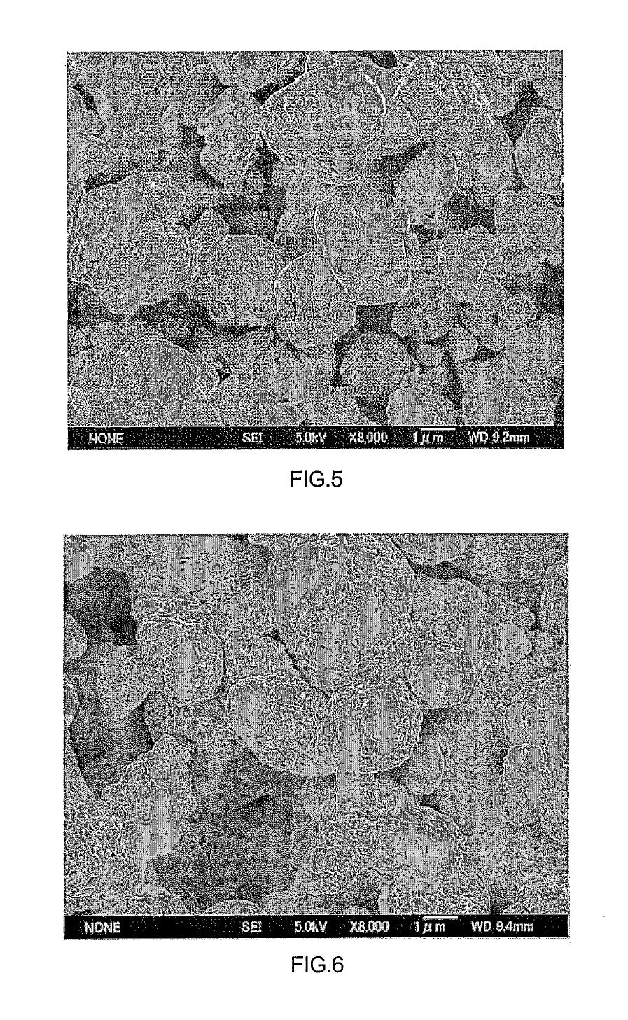

When the magnet is manufactured as described above, a photograph of the outer face of the compact before the oxidation-firing step is as shown in FIG. 5, and a photograph of the outer face of the compact or the magnet after the oxidation-firing step is as shown in FIG. 6. A comparison between FIG. 5 and FIG. 6 indicates that each of the material powders shown in FIG. 5 has an outer face with less unevenness, whereas each of the material powders shown in FIG. 6 has an outer face on which netlike ridges are developed. It is considered that the netlike ridges constitute the oxide films 32. Further, it is understood that the netlike ridges shown in FIG. 6 bond the adjacent material powders to each other. Thus, the material powders 10 are integrally bonded to each other by the oxide films 32.

The strength of the compact after the oxidation-firing step was evaluated by a bending strength test, and it was found that the strength was 2.0 MPa. Further, the residual magnetic density of the magnet was evaluated with the use of a vibrating sample magnetometer (VSM), and it was found that the residual magnetic flux density was 1.0T. Thus, it was found that it is possible to obtain the magnet having a sufficient strength and a sufficient residual magnetic flux density.

What is claimed is:

1. A method of manufacturing a magnet, comprising:
a forming step of forming material powders made of a R—Fe—N compound that contains a light rare earth element as R or material powders made of a Fe—N compound into a compact having a predetermined shape through compression forming; and
an oxidation-firing step of heating the compact formed of the material powders in an oxidative atmosphere to bond the material powders to each other by oxide films formed on the material powders.

2. The method of manufacturing a magnet according to claim 1, wherein, in the oxidation-firing step, the compact is heated at a temperature lower than a decomposition temperature of the R—Fe—N compound or the Fe—N compound.

3. The method of manufacturing a magnet according to claim 1, wherein the light rare earth element R is Sm.

4. The method of manufacturing a magnet according to claim 2, wherein the light rare earth element R is Sm.

5. A magnet that is formed by forming material powders made of a R—Fe—N compound that contains a light rare earth element as R or material powders made of a Fe—N compound into a compact having a predetermined shape through compression forming;
and heating the compact formed of the material powders in an oxidative atmosphere to bond the material powders to each other by oxide films formed on the material powders
